(19) United States
(12) Patent Application Publication
(10) Pub. No.: US 2017/0038962 A1
(43) Pub. Date: Feb. 9, 2017

(54) SYSTEM AND METHOD FOR RECEIVING A TOUCH INPUT AT A LOCATION OF A CURSOR EXTENDED FROM THE TOUCH INPUT ON A TOUCHSCREEN DEVICE

(71) Applicant: Cyanogen Inc., Palo Alto, CA (US)

(72) Inventors: Hayden Schoen, Tacoma, WA (US); Roman Birg, Seattle, WA (US)

(21) Appl. No.: 15/093,442

(22) Filed: Apr. 7, 2016

Related U.S. Application Data
(60) Provisional application No. 62/200,551, filed on Aug. 3, 2015.

(51) Int. Cl. G06F 3/0488; G06F 3/041

(52) U.S. Cl. CPC G06F 3/04883; G06F 3/0416

(57) ABSTRACT

A method and system for receiving input via a touchscreen device at a location of a cursor that is displayed by the touchscreen device extended in position on the touchscreen device from a touch input. The system detects movement of the touch input on the touchscreen and moves the cursor, translating a motion and a position of the touch input to a relative motion and position for the cursor on the touchscreen. The system can receive a touch input gesture via the touchscreen, and interpret an input corresponding to the touch input gesture at a location of the cursor on the touchscreen, which is extended in position from the touch input.

### CROSS-REFERENCE TO RELATED APPLICATIONS

The present application claims priority to and the benefit of U.S. Provisional Application No. 62/200,551, entitled “SYSTEM AND METHOD FOR RECEIVING A TOUCH INPUT AT A LOCATION OF A CURSOR EXTENDED FROM THE TOUCH INPUT ON A TOUCHSCREEN DEVICE,” filed Aug. 3, 2015. The disclosure of the above-listed application is hereby incorporated by reference in its entirety.

### BACKGROUND

Many modern computing devices receive input via touchscreen interfaces. Touchscreens are especially useful for receiving input for handheld devices. Smartphones and tablet computers, in particular, rely on touchscreens for receiving a majority of user input.

Despite touch being a preferred input mechanism for these devices, it can be cumbersome for a user to provide touch input at some locations of a device's display. As an example, when a user holds a tablet computer with both hands as if the user were reading the tablet like a book, the user may struggle to touch a majority of the tablet's screen without moving a hand that is securing the tablet. Likewise, a user interacting with a smartphone with one hand will find it difficult to reach with a thumb to an opposite side of a screen.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram of a touchscreen device in which a system for providing for an extended touch input via a cursor may operate.

FIG. 2 is a diagram of a system for providing for an extended touch input on a touchscreen device via a cursor.

FIG. 3 is a flow diagram of a process implemented by a system for providing for an extended touch input on a touchscreen device via a cursor, for providing for an extended touch input.

FIGS. 4A-D are drawings of a touchscreen device showing exemplary interfaces generated by the touchscreen device for providing for a touch input via a cursor generated by a system for providing for an extended touch input via the cursor.

### DETAILED DESCRIPTION

A method and system are described for receiving input via a touchscreen device at a location of a cursor that is displayed by the touchscreen extended in position on the touchscreen from a touch input. The system detects movement of the touch input on the touchscreen and moves the cursor, translating a motion and a position of the touch input to a relative motion and position for the cursor on the touchscreen. The system can receive a touch input gesture via the touchscreen, and provide an input for the touch input gesture at a location of the cursor on the touchscreen, which is extended in position from the touch input. The system improves user interaction with a touchscreen device, enabling user interaction via the touchscreen device at locations that are otherwise physically awkward or difficult for a user to touch.

The system provides a cursor, displayed via a touchscreen device, for an extended touch input after receiving an instruction from a user to provide for an extended touch input. For example, the system may receive a selection by a user of an icon associated with providing for an extended touch input. The system detects a touch input on the touchscreen device for commencing using a cursor. In some implementations, the detected touch input is a touch input received from a user for instructing the system to provide for an extended touch input.

The system causes the touchscreen device to display an interface including a cursor. In some implementations, a cursor is initially displayed at a location of the detected touch input. In other implementations, a cursor is initially displayed at a location offset from a location of a detected touch. In some implementations, a cursor is initially displayed at a location of an element of a graphical user interface displayed by a touchscreen device. For example, a cursor may originate over a link of a website that is being browsed when an extended cursor is activated.

The system detects a movement of the touch input and moves the cursor by translating a motion and a position of the touch input to a relative motion and a position for the cursor. In some implementations, the system translates a sensed motion and position of a touch input into an extended cursor's motion and position by adding a cursor offset, calculated based on a detected movement of a touch input, to a location of the cursor. A cursor offset includes an ordered pair, which can be added to coordinates for a cursor. In some implementations, a cursor offset is calculated by multiplying a detected movement of the touch input by a predetermined movement weight. For example, if a detected movement of a touch input on a touchscreen device is detected from a location having coordinates (X₁,Y₁) to a location having coordinates (X₂,Y₂), and a predetermined movement weight is A, a cursor offset is calculated as (AX₂−AX₁,AY₂−AY₁). The system can calculate a new location for a cursor by adding a cursor offset to a previous location of the cursor. For example, if a first location for a cursor has coordinates (X₃,Y₃), a new location after a detected movement of a touch input is (X₃+AX₂−AX₁,Y₃+AY₂−AY₁). The system bounds a location for an extended cursor to a display of a touchscreen device. For example, the system may limit coordinates for an extended cursor to coordinates within bounds of a display of the touchscreen device.

The system can identify a gesture in touch input, which is interpreted as an input at a location of the cursor. For example, the system may detect a release of a touch input and a tap, which the system interprets as a tap gesture at a location of a cursor. Other gestures include a long hold and a double tap. The system generates an instruction for the touchscreen device to execute a function associated with a received gesture at a location of a cursor.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

The following discussion includes examples of a system for providing for an extended touch input via a cursor extended from a touch input received via a touchscreen device. The system is described with respect to a number of processes that it may implement and numerous examples of how it may be implemented.

### Suitable Environments

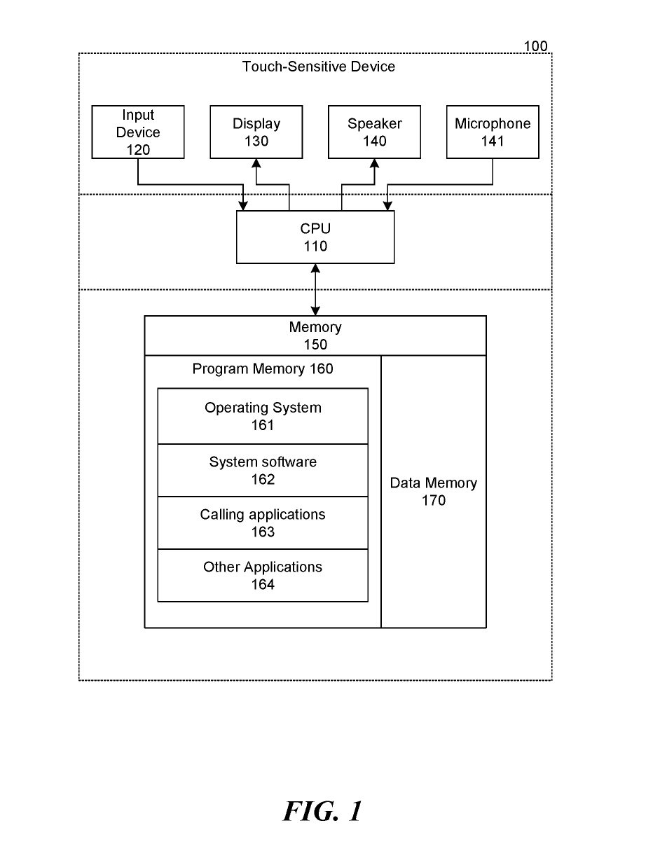

FIG. 1 is a simplified system block diagram of hardware components of a touchscreen device 100 for implementing a system for applying a touch input at a location of a cursor that is extended in distance from the touch input. The device 100 includes one or more input devices 120 that provide input to the CPU (processor) 110, notifying it of actions performed by a user, such as a received touch and gesture from the user. The actions are typically mediated by a hardware controller that interprets the signals received from the input device and communicates the information to the CPU 110 using a known communication protocol. Input devices 120 include, for example, a capacitive touchscreen, a resistive touchscreen, a surface wave touchscreen, a surface capacitance touchscreen, a projected capacitive touch screen, a mutual capacitance touchscreen, a self-capacitance sensor, an infrared touchscreen, an infrared acrylic projection touchscreen, an optical imaging touchscreen, or the like. Input devices provide touch input data, which are used by the system for providing for an extended touch input.

The CPU may be a single processing unit or multiple processing units in a device or distributed across multiple devices. Similarly, the CPU 110 communicates with a hardware controller for a display 130 on which text and graphics, such as an extended cursor, are displayed. One example of a display 130 is a display of the touchscreen that provides graphical and textual visual feedback to a user. In some implementations, the display includes the input device as part of the display, such as when the input device is a touchscreen. A speaker 140 is also coupled to the processor so that any appropriate auditory signals can be passed on to the user. The touch-sensitive device includes a microphone 141 that is also coupled to the processor so that spoken input can be received from the user. The microphone and speaker can also be used for facilitating a voice call. In some implementations, the touch-sensitive device includes an image sensor, which may be used for video calls.

The processor 110 has access to a memory 150, which may include a combination of temporary and/or permanent storage, and both read-only and writable memory (random access memory or RAM), read-only memory (ROM), writable non-volatile memory, such as flash memory, hard drives, floppy disks, and so forth. The memory 150 includes program memory 160 that contains all programs and software; programs and software include an operating system 161, system software 162 including software for implementing a system for providing for an extended touch input via a cursor extended from a touch input received via a touchscreen device, calling applications 163 (e.g., a dialer application for providing calls over a cellular service, a voice-over IP (VoIP) calling application), and any other application programs 164, such as an application for providing for and receiving extended touch input. The memory 150 also includes data memory 170 that includes any configuration data, settings, user options and preferences that may be needed by the program memory 160, or any element of the device 100.

The touch-sensitive device also includes a communication device capable of communicating wirelessly with a base station or access point using a wireless mobile telephone standard, such as the Global System for Mobile Communications (GSM), Long Term Evolution (LTE), IEEE 802.11, or another wireless standard. The communication device may also communicate with another device or a server through a network using, for example, TCP/IP protocols. For example, the touch-sensitive device may utilize the communication device to communicate with another device and to offload some processing operations to a more robust system or computer. The touch-sensitive device also includes motion sensors, such as accelerometers; environmental sensors, such as ambient air temperature; and position sensors, including orientation sensors. The touch-sensitive device also includes a Global Positioning System (GPS) receiver, and/or other sensors or modules for identifying a location of the device.

### Suitable Systems

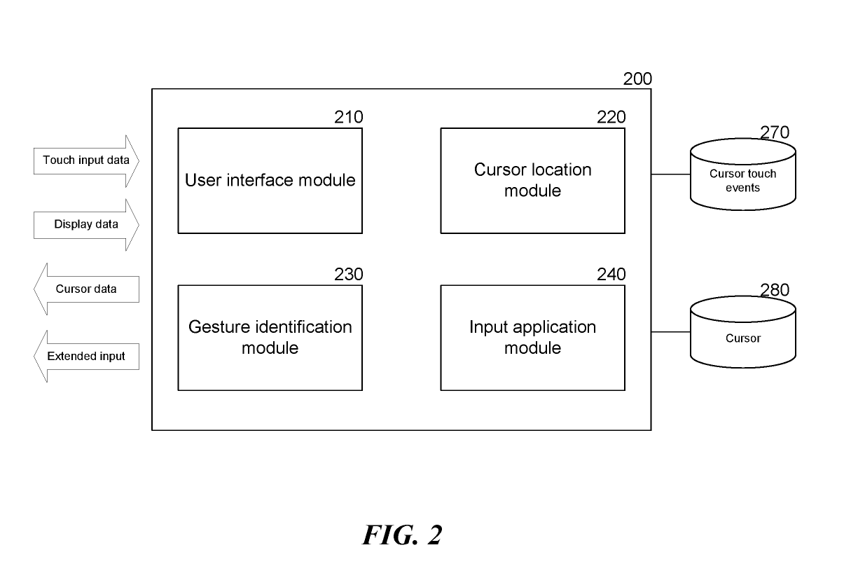

FIG. 2 is a block diagram of a system 200 for providing for an extended touch input via a cursor extended from a touch input detected on a touchscreen device. The system includes a user interface module 210, a cursor location module 220, a gesture identification module 230, and an input application module 240. The system receives touch input data and display data and outputs cursor data and extended input. The system accesses data in cursor touch event data storage 270 and cursor data storage 280. The system may be implemented in a touchscreen device, such as the touchscreen device 100, including a smartphone, tablet computer, or the like. The system causes a touchscreen device to display a cursor as an overlay over a graphical user interface, and enables a user to control the cursor via touch input and provide input via the cursor. The system receives touch input via the touchscreen device and moves the cursor by translating a motion and a position of the touch input to a relative motion and position for the cursor on the touchscreen. The system can receive a touch input gesture via the touchscreen and apply an associated input at a location of the cursor on the touchscreen, which is extended in position from the touch input.

Touch input data received by the system includes data generated by a touchscreen device in response to detecting a touch input. Touch input data includes coordinates for a detected touch. For example, touch input data may include coordinates for a centroid of a detected touch. Touch input data may also include events associated with a detected touch. For example, in an Android™ computing environment, the system may receive motion events, including ACTION_DOWN, ACTION_UP, ACTION_MOVE, and so forth. Touch input may include a selection by a user of a displayed icon or option added to a graphical user interface by the system, for receiving from a user an instruction to provide for an extended touch input via a cursor. Touch input can also include a gesture received and recognized by a touchscreen device, including a gesture corresponding to a gesture of an action trigger for providing input at a location of a cursor displayed by a touchscreen device. Touch input data can also include touch data from touch-sensitive sensors on a side or a back of a device, including processed touch data from one of these sensors, which may include an indication that the device is being held in a left hand, a right hand, or both hands.

Display data includes information about a display of a touchscreen device. Display data includes a size of a touchscreen display of a device. A size of a touchscreen display may include dimensions of a touchscreen display in pixels. A size of a touchscreen display may include physical dimensions of a touchscreen display, such as the display's dimensions in inches. Display data can also include information about a graphical user interface being displayed by a touchscreen device. Information about a graphical user interface being displayed includes elements of a graphical user interface and locations of the elements in the graphical user interface. For example, display data may identify coordinates for an address bar of an Internet browser in a foreground of a graphical user interface. In some implementations, display data includes an orientation of a display of a touchscreen device. For example, display data can include that a touchscreen device is currently in a portrait orientation. Display data can be provided, for example, by an operating system of a device or an application running on a device.

Cursor data includes information for drawing a cursor as an overlay on a graphical user interface being displayed by a touchscreen device. Information for drawing a cursor may include a shape for the cursor or an image file or other image data including the cursor. Information for drawing a cursor also includes a size of the cursor and coordinates for displaying the cursor. In some implementations, coordinates for displaying a cursor are coordinates for displaying a reference pixel of the cursor, such as a top left pixel of the cursor or a centroid of the cursor. Cursor data also includes information for drawing a graphical element that a user can select to instruct the system to provide for an extended touch input via a cursor. For example, cursor data may include information for drawing a button that can be selected by a user to instruct the system to provide for an extended touch input. Cursor data may include instructions for displaying the cursor and other graphical elements of the cursor data. Cursor data also includes images and/or animations associated with providing a user a visual indication of a touch input. For example, the system may generate an animation overlay associated with a touch input, providing an indication at a location of the touch input, via a graphical user interface of a touchscreen, of a gesture received by the system while the system is providing for an extended touch input. Cursor data includes other needed information for displaying these additional overlays and/or animations, including a size for the overlays and/or animations, a location for the overlays and/or animations, graphical elements of the overlays and animations, and so forth. Cursor data can also include an instruction that a touchscreen device cease displaying a cursor or other overlays.

Extended input includes data for applying an input at a location of a cursor. Input may include a gesture, an action, or other input touch events. For example, in an Android™ computing environment, extended input may include a motion event, such as ACTION_DOWN, and a location for the motion event, such as coordinates for a centroid of a cursor being displayed. Extended input may include that a gesture, such as a long press, is to be applied at a location of a cursor. Extended input may include an action that is to be taken at a location of a cursor. As discussed herein, the system can compare touch input received via a touchscreen device with gesture data associated with action triggers stored in cursor touch events data storage 270, and determine, based at least in part on a gesture associated with an action trigger being identified in the touch input, that the action trigger has been triggered. The system applies an action associated with the triggered action trigger at a location of a cursor on the graphical user interface, generating extended input for applying the action.

The user interface module 210 generates cursor data. The user interface module receives display data and touch input data, and data from the cursor location module 220, gesture identification module 230, and input application module 240. Cursor data includes appearance details for a cursor and location information for the cursor. Cursor location information is received from the cursor location module 220. The user interface module can update cursor data at various times, including periodically or when new location information for a cursor is received from the cursor location module. Appearance details for a cursor are contained in cursor data storage 280. Appearance details can be created and stored by an administrator or publisher of the system. Appearance details include an image for a cursor, a shape for a cursor, a size for a cursor, a color for a cursor, and/or the like. In some implementations, the user interface module is configured to generate an overlay of a cursor to be displayed by a touchscreen device or to provide instructions to a touchscreen device for generating an overlay. In some implementations, the user interface module is configured to output different appearance details for a cursor at a first instance relative to a second instance based at least in part on received touch input data. For example, cursor data may include animation details that are displayed by a touchscreen device when a gesture is received via the touchscreen. The user interface module can also receive instructions from the input application module 240 to change a visual appearance of a displayed cursor, and it is configured to change the visual appearance of the displayed cursor accordingly. For example, the system may momentarily color a cursor differently when an action trigger is received. The user interface module can also receive an instruction from the gesture identification module 230

The user interface module 210 generates other overlays and/or graphical user interfaces associated with providing for an extended touch input by a user. The user interface module can generate an overlay that a user can select via a touchscreen device to instruct the system to provide for an extended touch input via a cursor. An overlay for launching an extended touch cursor can initially be displayed at a predetermined default location on a user interface of a display. For example, the user interface module can generate an icon overlay for display on a GUI at a lower corner of a smartphone's touchscreen display, enabling a user to quickly select the icon overlay using a thumb while holding and controlling the smartphone with one hand. In some implementations, the user interface module determines a location on a GUI for initially displaying an icon overlay for launching an extended touch cursor based at least in part on how a device is being held. For example, the user interface module may receive an indication of whether a smartphone is being held by a user in a left hand, a right hand, or in both hands, and the user interface module displays an icon overlay for launching an extended touch cursor at a location determined based at least in part on how the smartphone is being held. In some implementations, when the system determines that a device is being held in a right hand, the system displays an icon overlay for launching an extended touch input at a first location associated with right hand mode, and when the system determines that the device is being held in a left hand, the system displays an icon overlay for launching an extended touch input at a second location, different from the first location, associated with left hand mode. In some implementations, a location for an icon overlay for launching an extended touch input in a left hand mode is in a lower-left region of a GUI displayed by a device, and a location for an icon overlay for launching an extended touch input in a right hand mode is in a lower-right region of a GUI displayed by the device.

The user interface module can determine how a device is being held in various ways. In some implementations, a device includes a sensor and associated circuitry and software for determining whether the device is being held by a left hand or by a right hand or by both hands, and the user interface module receives an indication from the sensor and associated circuitry and software of how the device is being held. In some implementations, the user interface module receives user input of a preference for left or right hand mode, and the user interface module determines whether a device is being held in a left hand or a right hand based on the preference provided by the user. For example, the system may receive a selection by a user of an option to use a right hand input mode or an option to use a left hand input mode, and the user interface module can display an icon overlay at a first location if the user has selected right hand mode and at a second location if the user has selected left hand mode.

The user interface module 210 also generates overlays for display by a touchscreen device while a touch input is being received. For example, the user interface module 210 may generate an overlay that is displayed at a location of a touch input when a gesture is received corresponding to a gesture for an action trigger. The overlay may include an indication of a progress of a gesture. For example, for a long press gesture, the user interface module may generate and output an overlay showing a progress of the long press, including an animated progress bar indicating a remaining time that the long press gesture needs to be held to provide the gesture.

The cursor location module 220 determines a location for a cursor and provides cursor location information to the user interface module 210, the gesture identification module 230, and the input application module 240. The cursor location module receives touch input data and display data received by the system and obtains cursor data from cursor data storage area 280.

The cursor location module 220 determines a location for a cursor based on received touch input and a previous location of the cursor. A previous location of the cursor may be an initial location of the cursor. An initial location of a cursor is a location on a touchscreen device at which the system initially displays a cursor after a user requests to provide touch input via an extended cursor. An initial location of a cursor can reference a particular point of a cursor, such as its centroid. The cursor location module identifies an initial location for a cursor based at least in part on initial location details contained in cursor data storage 280. Initial location details may include a predetermined absolute location for a cursor. For example, initial location details may include predetermined coordinates for an initial location of a cursor. In some implementations, initial location details include a location that is determined based at least in part on an initial touch input received by the system after receiving an instruction to provide for an extended touch input. For example, initial location details may include that an initial location of a cursor be a distance, determined based on a diameter of the cursor, from an initial touch input sensed by a touchscreen, in a direction from the initial touch input that is toward a centroid of the touchscreen. In some implementations, initial location criteria include a centroid for a touchscreen device. In some implementations, initial location criteria include that a centroid of the cursor be at a centroid of an element of a graphical user interface being displayed by a touchscreen device. For example, display data may identify locations of elements of a graphical user interface, such as coordinates for centroids of elements of the graphical user interface, and initial location criteria may specify that an initial location for a cursor be at a location of a predetermined element of the graphical user interface. A predetermined element may be a specific element, such as an address bar of an Internet browser when it is identified in received display data. In some implementations, a predetermined element is an element of a graphical user interface that is furthest in distance from an initial touch received by the system. In some implementations, initial location criteria includes that an initial location of a cursor be directly under a received touch input. In some implementations, initial location details include a position relative to an overlay that a user can select via a touchscreen device to instruct the system to provide for an extended touch input via a cursor. For example, initial location details may include that a cursor be initially displayed adjacent to an overlay that is selected by a user to launch the cursor for extended touch input.

The system 200 enables a user to move a cursor being generated by the system and displayed by a touchscreen device by moving a touch input being provided by the user. The cursor location module 220 identifies a new location for a cursor based on a previous location of the cursor and touch input data received by the system. Touch input data received by the system may include initial coordinates of a touch input received by a touchscreen device, and subsequent coordinates for the touch input, as the touchscreen device detects movement of the touch input. For example, in an Android™ computing environment, touch input data may include a motion event, such as ACTION_MOVE, including coordinates for intermediate points of a touch input after an ACTION_DOWN event and before an ACTION_UP event. In some implementations, the cursor location module calculates a new location for a cursor by adding a cursor offset, calculated by multiplying a determined movement of a touch input by a movement weight, to a previous location for the cursor. For example, for a movement of a touch input from a location having coordinates (X₁,Y₁) to a location having coordinates (X₂,Y₂), the cursor location module calculates a detected touch input movement along an x-axis, X_{M}, as X_{M}=X₂—X₁, and a detected touch input movement along a y-axis, Y_{M} as Y_{M}=Y₂−Y₁. Using a movement weight, A, the cursor location module calculates a cursor offset, C_{Offset}, as C_{Offset}=(A·X₂−A·X₁,A·Y₂−A·Y₁). The cursor location module calculates a new location for the cursor by adding the cursor offset to a previous location of the cursor. For example, for a cursor at a location having coordinates, (X₃,Y₃), the system calculates a new location, L_{N}, for the cursor as ordered pair, L_{N}=(X₃+A·X₂−A·X₁,Y₃+A·Y₂−A·Y₁). The cursor location module can provide updated location information for a cursor periodically or when a new location for the cursor is calculated.

The cursor location module is configured to confine a new cursor location to a touchscreen display, such that the new cursor location is not outside of the display bounds. The cursor location module compares a new location calculated for a cursor to bounds of the touchscreen display and modifies the new location so that it is within the bounds of the touchscreen. In some implementations, the cursor location module sets an x-coordinate or y-coordinate of a new location for a cursor to an extreme coordinate, such that it is on an edge of a display, when the new location is determined to be outside the bounds of a touchscreen. For example, for a touchscreen device with a bounds of a display along an x-axis from 0-1000 and a bounds along a y-axis from 0-2000, the cursor location module limits a location for a cursor to locations having coordinates within the bounds by setting an x-coordinate of a new location to zero when the x-coordinate of a calculated new location is less than zero or to 1000 when the x-coordinate of the new location is greater than 1000. The cursor location module limits the new location with respect to its y-coordinate in a similar manner.

The gesture identification module 230 identifies a gesture in a received touch input and provides action data to the input application module 240. Action data includes information associated with input to be applied to a graphical user interface generated by a touchscreen device, identified based at least in part on a received gesture. The gesture identification module may also provide input to the user interface module, instructing the user interface module to cease generating a cursor to display on a graphical user interface. The gesture identification module accesses cursor touch events in cursor touch events data storage 270. A cursor touch event includes a gesture or another predetermined touch input event. The system compares gestures associated with cursor touch events with touch input data, including touch input detected by a touchscreen device for moving a cursor, additional pointers detected by the touchscreen device while touch input is being detected, a detected release of a touch input, and subsequent touch input detected after a detected release of touch input. The received touch input may include gestures that have already been recognized by a touchscreen device. Based on the comparison, the system determines whether a cursor touch event has been received. For example, in an Android™ computing environment the system may compare a received touch input including a motion event ACTION_DOWN and motion event ACTION_UP, received at a same location on a touchscreen device, to gestures of cursor touch events, and determine that a cursor touch event has been received when a gesture that the cursor touch event is associated with is identified in touch input.

Cursor touch events include action triggers. An action trigger includes a gesture and an associated action. When the gesture identification module determines that a received cursor touch event is an action trigger, it provides the action and information associated with the action to the input application module 240. In some implementations, if a cursor touch event is identified that is not an action trigger, the gesture identification module 230 instructs the user interface module 210 to cease providing for an extended touch input. In some implementations, if a cursor touch event is identified that is not an action trigger, the gesture identification module does not instruct the user interface module to cease providing for an extended touch input until a cursor touch event that includes an instruction to end providing for an extended touch is received. In some implementations, the gesture identification module is configured to receive a gesture associated with commencing providing for an extended touch input, and the gesture identification module instructs the user interface module to provide for an extended touch input. For example, a predetermined gesture, such as a touch input wiggling back and forth, may correspond to an instruction to commence providing for an extended touch input, and the system may launch an extended cursor interface for providing for an extended touch input.

The input application module 240 generates extended input based at least in part on an action identified by and received from the gesture identification module 230 and cursor location information received from the cursor location module. Extended input includes data for applying an action on a graphical user interface generated by a touchscreen device. The input application module can access data for providing an action, including instructions and associated information, in cursor touch events data storage 270. In some implementations, extended input includes a gesture or another touch input event recognized by the touchscreen device that is associated with an action trigger identified by the gesture identification module. The input application module can identify the gesture or other touch input event based on the action that is to be applied. The input application module can maintain a list of actions and associated instructions and/or gestures to apply at a location of a cursor, and it can identify the actions and associated instructions in the list. The input application module can identify a location for the input based on cursor location information provided by the cursor location module.

### Example Processes

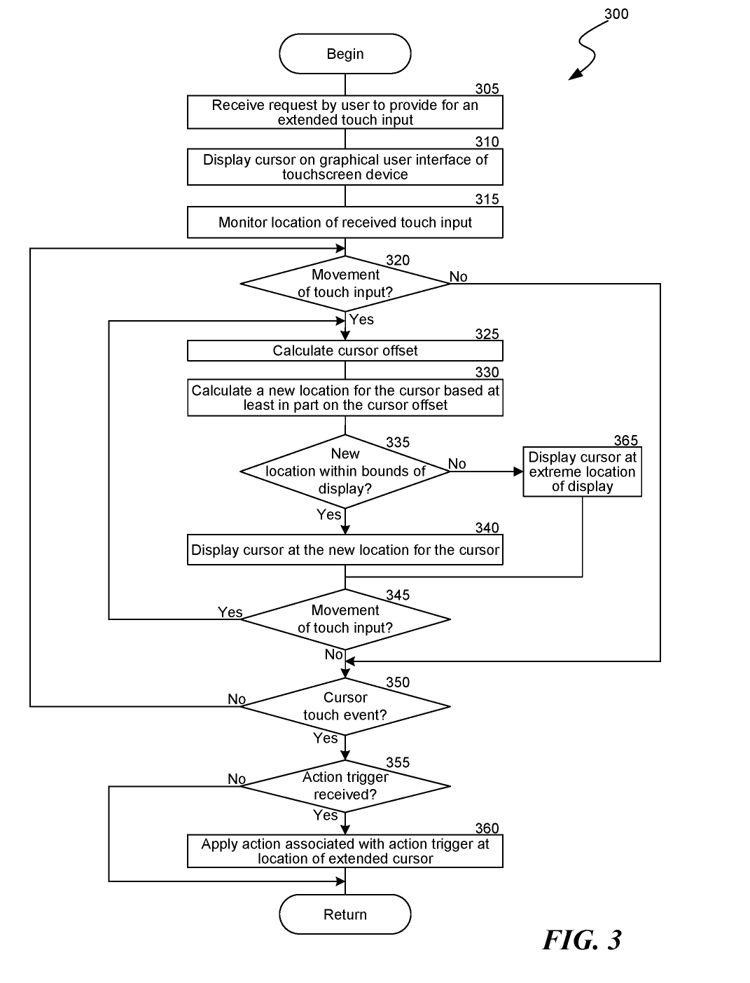

FIG. 3 is a flow diagram of a process 300 performed by the system 200 for applying an action at a location of a cursor on a graphical user interface displayed by a touchscreen device, based at least in part on a touch input received at a location on the touchscreen device that is removed from the cursor. The system enables a user to control a location of the cursor by providing touch input via the touchscreen device, enabling the user to more easily interact with a graphical user interface displayed by the touchscreen device. The system can provide extended touch functionality for an application or a touchscreen device generally, incorporated as a function of an application, provided by an operating system of the touchscreen device, provided as a separate application that interacts with a graphical user interface being generated by the touchscreen device, or in other implementations.

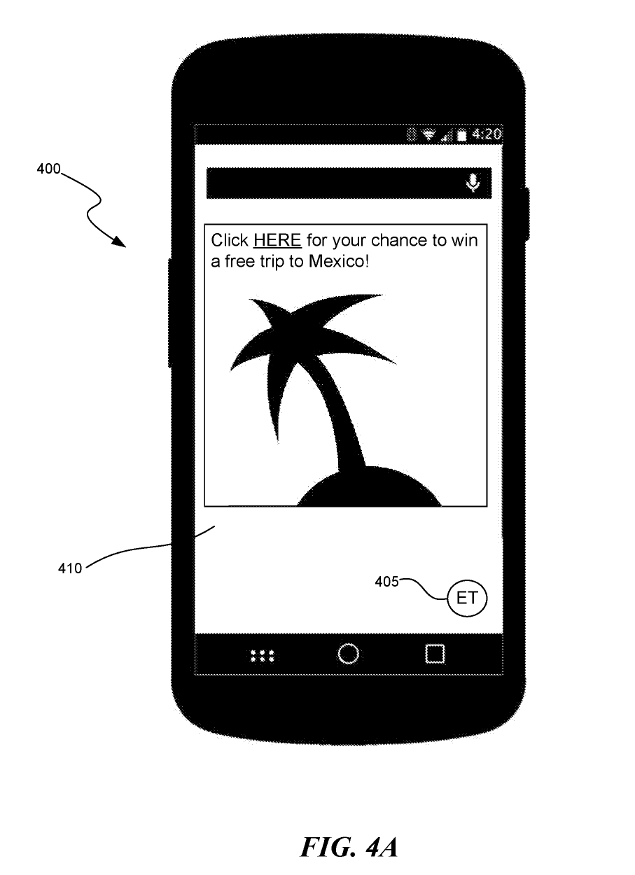

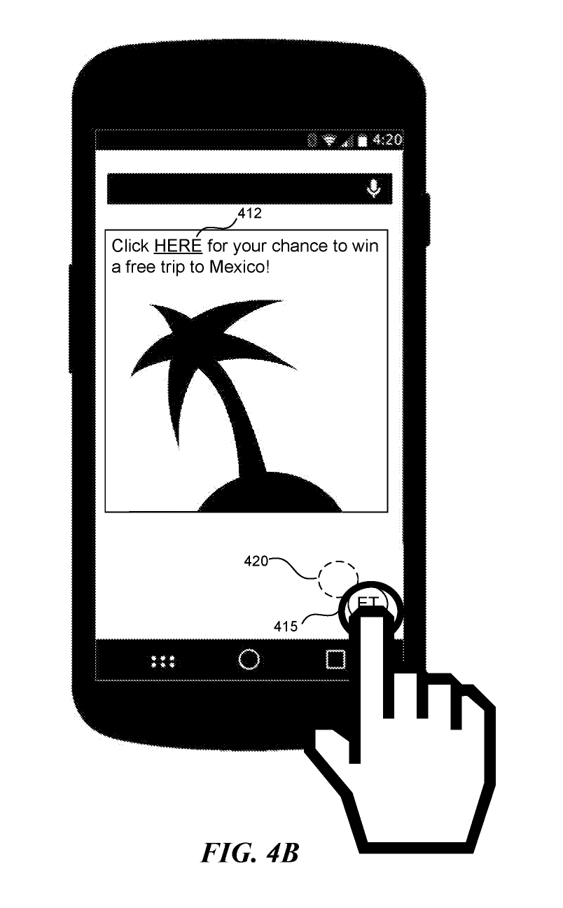

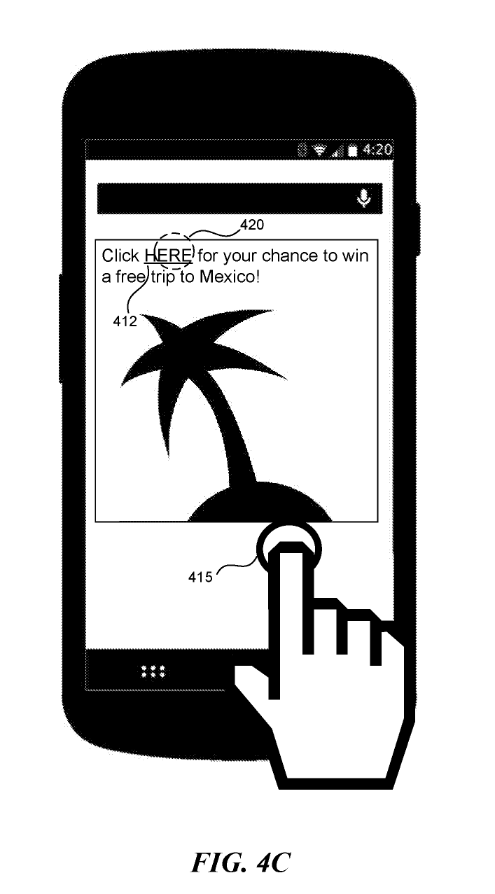

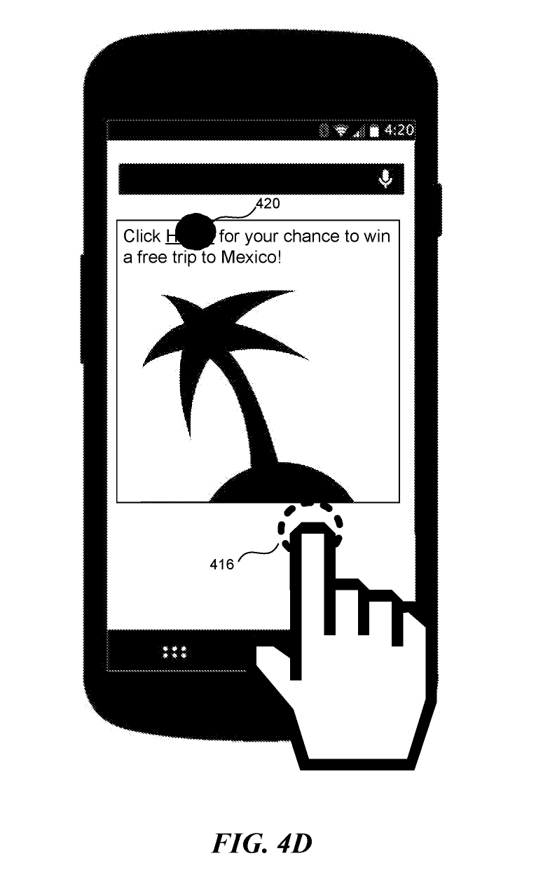

At a block 305, the system 200 receives a request from a user to provide for an extended touch input on a touchscreen device. In some implementations, the system causes a touchscreen device to display an icon associated with providing an extended touch input, and a request to provide for an extended touch input is inferred in a selection by a user of the icon. FIGS. 4A-D show a representative touchscreen device 400 displaying graphical user interfaces for providing for an extended touch input by a user via a cursor. FIG. 4A shows a graphical user interface 410 that includes a button element 405 that a user can select to instruct the system to provide for an extended touch input. In some implementations, the system displays an icon associated with providing an extended touch input at a preset location. In some implementations, the system determines a location to display an icon for launching an extended touch input based at least in part on how a device is being held. For example, the system can display an icon for launching an extended touch input at a first predetermined location on a GUI displayed by a device when the system determines that the device is being held by a left hand and the system can display the icon at a second predetermined location on the GUI when the system determines that the device is being held by a right hand. In some implementations, the system displays an icon for launching an extended touch input on a left side of a navigation bar when a device is being held in a left hand and on a right side of a navigation bar when a device is being held in a right hand. The system can receive requests to provide for an extended touch input in other ways. In some implementations, the system provides for an extended touch input by default, enabling a user to automatically control a cursor, displayed on a graphical user interface, by providing touch input. In some implementations, the system receives a gesture corresponding to a request to provide for an extended touch input. For example, the system may monitor touch input received by a touchscreen device, and when it identifies touch input corresponding to a gesture of quick movements back and forth, the system infers a request from a user to provide for an extended touch input.

At a block 310, the system displays a cursor via the touchscreen device. The cursor can be an overlay on a graphical user interface displayed by the touchscreen device. In some implementations, the system displays the cursor initially at a predetermined location on a graphical user interface of the touchscreen device. FIG. 4B shows the touchscreen device 400 showing a graphical user interface including a cursor 420 displayed over the graphical user interface by the touchscreen device. The cursor 420 is being displayed at a predetermined initial location, adjacent to the button 405. The system generates the cursor 420 on the graphical user interface in response to receiving a touch input 415 by a user of the button 405 for providing an extended touch. In some implementations, the system displays the cursor at an initial location that the system identifies based at least in part on a touch input received by the touchscreen device. For example, the system can display a cursor at a location identified based at least in part on a location of a received gesture for requesting that the system provide for an extended touch input. The system can display the cursor at the location of the touch input, at a location relative to the location of the touch input, or the like. For example, the system can display a cursor that is a circle initially at a location that is offset from received touch input by a diameter of the circle. In some implementations, the system displays the cursor at an initial location that is identified based at least in part on an element of a graphical user interface. For example, the system may display a cursor on a search bar initially.

The system 200 detects a touch input and, at a block 315, monitors a location of the touch input. In some implementations, the detected touch input is a touch input received at block 305 for requesting that the system provide for an extended touch input. For example, referring again to FIG. 4B, the touch input 415 of the button 405 can be the detected touch input whose location is monitored. The system monitors a location of the touch input by comparing received location information to previously-received location information for the touch input. In some implementations, the system samples received location information for the detected touch on a periodic basis. In some implementations, the system continuously receives location information for the detected touch. For example, the system may monitor coordinates for a centroid of a detected touch input for a change in the coordinates. At a decision block 320, the system determines whether movement has been detected in received touch input. If the system determines that no movement has been detected, the process proceeds to a decision block 350. In some implementations, the system determines that no movement has been detected when a received touch input does not move before it is no longer sensed by the touchscreen device. In some implementations, the system determines that no movement has been detected when a received touch input does not move for a predetermined duration of time. In some implementations, the system determine that no movement is detected when a predetermined gesture, such as a tap, is received.

If at decision block 320, the system 200 determines that movement has been detected, the process 300 proceeds to a block 325, and the system 200 calculates a cursor offset based on the detected movement. A cursor offset is a value used for moving a cursor relative to a detected movement of a touch input. In some implementations, a cursor offset is equal to a movement weight multiplied by a detected touch input movement. In some implementations, a movement weight is a constant. For example, a movement weight can be a predetermined value, provided by an administrator of the system, a publisher of the system, a user, or the like. In other implementations, a movement weight is a variable. A movement weight may vary based at least in part on a location of a cursor on a graphical user interface. As an example, the system may reduce a movement weight when a cursor approaches an interactive element of a graphical user interface, such as a button that is selectable via touch input. Similarly, a movement weight may be reduced when a cursor approaches a boundary of a display.

The system calculates a detected touch input movement based on a difference between locations of a present and previous touch input. For example, the system may detect movement of a touch input from a location having coordinates (X₁,Y₁) to a location having coordinates (X₂,Y₂). The system may calculate a detected touch input movement along an x-axis, X_{M}, as X_{M}=X₂−X₁, and a detected touch input movement along a y-axis, Y_{M} as Y_{M}=Y₂−Y₁. Using a movement weight, A, the system calculates a cursor offset, C_{Offset}, as an ordered pair, C_{Offset}=(A·X₂−A·X₁,A·Y₂−A·Y₁).

At a block 330, the system 200 calculates a new location for the cursor. The system calculates a new location for the cursor by adding the cursor offset to a previous location of the cursor. For example, considering a cursor located most recently at a location on a graphical user interface with coordinates (X₃,Y₃), the system calculates a new location by adding a calculated cursor offset equivalent to ordered pair (A·X₂−A·X₁,A·Y₂−A·Y₁) to a location having coordinates (X₃,Y₃). Thus, a new location, L_{N}, may be represented as an ordered pair, L_{N}=(X₃+A·X₂−A·X₁,Y₃+A·Y₂−A·Y₁).

At a decision block 335, the system 200 determines whether the new location calculated for the cursor is within a bounds of the touchscreen display. The system determines whether the new location calculated for the cursor is within the bounds of the touchscreen display by comparing the bounds of the touchscreen display to the new location for the cursor. For example, for a touchscreen device with a bounds of a display along an x-axis from 0-1000 and a bounds along a y-axis from 0-2000, the system calculates a new location outside of the bounds of the display when the x-coordinate of the new location is less than 0 or greater than 1000, or the y-coordinate is less than 0 or greater than 2000. If the system determines that the new location is not within the bounds of the display, the process 300 proceeds to a block 365, and the system 200 sets a location of the cursor at an extreme location of the touchscreen display and displays the cursor at the extreme location. An extreme location is a location having coordinates including a boundary x-coordinate or a boundary y-coordinate. A boundary x-coordinate or a boundary y-coordinate can be a greatest or least possible value for a display. For example, for a display having a bounds along an x-axis from 0-1000 and a bounds along a y-axis from 0-2000, for a new location having coordinates (344, 2004), the system determines that the new location is not within the bounds of the touchscreen because the y-coordinate is a value, 2004, that is greater than a bounds of the display along the y-axis, 2000. Accordingly, the system sets an extreme location for a centroid of the cursor at a location having coordinates (344, 2000). The system 200 displays the cursor at the extreme location of the display, and the process 300 proceeds to a decision block 345.

If at block 335 the system 200 determines that the new location is within the bounds of the display, the process 300 proceeds to a block 340, and the system displays the cursor at the new location for the cursor. For example, FIG. 4C shows the touchscreen device 400 showing a graphical user interface including the cursor 420 displayed at a new location on the graphical user interface, over a link 412 in an advertisement displayed by the touchscreen device. The user has moved the touch input 415, and the system has translated motion and position of the touch input 415 to a relative motion and position for the cursor 420 on the touchscreen. The process then proceeds to decision block 345.

At decision block 345, the system determines whether movement has been detected in the touch input. The system can monitor for a movement in the touch input in the ways discussed above with respect to block 315, and the system can determine whether movement of the touch input has been detected, or not, as it did at block 320. If movement is detected, the process returns to block 325, and the system calculates a cursor offset based on the detected movement. If movement is not detected, the process proceeds to a decision block 350.

At decision block 350, the system 200 determines whether a cursor touch event has occurred. A cursor touch event includes an event at a touch input that is associated with affecting a cursor being displayed by the system and/or a graphical user interface at a location of the cursor. A cursor touch event is associated with a predetermined touch input. Touch input includes a touch input for moving a cursor, an absence or a removal of touch input and subsequent touch input, gestures, additional touch pointers, and the like. The system determines whether a cursor touch event has occurred by comparing cursor touch events with detected touch input. A cursor touch event may include a gesture. For example, a cursor touch event may include a long press, including a touch input held at a location on a touchscreen for a time period greater than a threshold. The system may identify a long press when a centroid of a detected touch input has not varied beyond a predetermined perimeter for a predetermined duration of time during a touch. In some implementations, a cursor touch event includes that a touch input that was detected is no longer detected by a touchscreen. For example, in an Android™ computing environment, a cursor touch event may include that after having received a Motion Event ACTION_DOWN, the system receives a touch event ACTION_UP. In some implementations, a cursor touch event includes that a new pointer is detected while a touch input of a first pointer is being received. For example, such a cursor touch event may be identified when a first touch input (e.g., a touch input from a first finger) is being received and is controlling a cursor displayed by a touchscreen device, and the touchscreen device determines that a new pointer (e.g., a touch input from a second finger) has been detected by the touchscreen device.

When no cursor touch event is identified, the process 300 returns to decision block 320, and the system 200 monitors for movement of the touch input. In some implementations, the system determines that no cursor touch event has occurred when the system has not detected an occurrence related to a touch input that is associated with a cursor touch event. In some implementations, the process returns after the system detects neither movement of a touch input nor a cursor touch event. For example, the system may wait a predetermined duration of time for a touch input or a cursor touch event, and when neither is received, after the predetermined duration of time, the system ceases providing for an extended touch input. When a cursor touch event is identified by the system, the process proceeds to a decision block 355.

At decision block 355, the system 200 determines whether an action trigger has been received. An action trigger is a cursor touch event that is associated with an action for the system to apply at a location of a cursor when a gesture associated with the action trigger is received. The system determines whether an action trigger has been received by comparing action triggers with detected touch input, attempting to identify touch input corresponding to a gesture for an action trigger. The system receives an action trigger when received touch input corresponds to a gesture for the action trigger. If the system 200 determines that no action trigger has been received, the process 300 returns. The system may determine that no action trigger has been received when received touch input does not correspond to a gesture for an action trigger. In some implementations, when the system is displaying a cursor and determines that a cursor touch event has been received via a touchscreen device and the cursor touch event does not correspond to an action trigger, the system causes the touchscreen device to stop drawing the cursor on the touchscreen device. If the system determines that an action trigger has been received, the process proceeds to a block 360.

At block 360, the system 200 applies an action associated with the received action trigger at a location of the cursor on the touchscreen device. Applying an action includes providing input to the touchscreen device for applying the action at a location of the cursor. For example, an action associated with an action trigger including a tap gesture may be a “tap” input at a location of a centroid of a cursor. Other actions associated with action triggers include input corresponding to a long press at a location of a cursor and input corresponding to gestures, such as pinch to zoom. For example, in an Android™ computing environment, for an action trigger corresponding to a “tap,” the system can apply a motion event ACTION_DOWN and a motion event ACTION_UP when the action trigger corresponding to the “tap” is identified.

The system may provide visual indications and/or other indications via a touchscreen device for notifying a user of a received action trigger. FIG. 4D shows the touchscreen device 400 showing a graphical user interface including the cursor 420 and a received touch input corresponding to an action trigger. The system has generated and the touchscreen device has displayed an action indicator 416. An action indicator can provide a visual indication of an action trigger identified based on a user's touch input. In some implementations, an appearance of an action trigger changes based on received input. For example, for an action trigger corresponding to a long press at a location of a cursor, the system may generate an action indicator that includes a progress bar indicating a duration of time that has passed since a touch input for the action trigger began being received, and a remaining amount of time that the touch input corresponding to the action trigger must be received in order to satisfy the action trigger of the long press. FIG. 4D also shows a different visual appearance for the cursor 420. In some implementations, the system changes visual appearance details for a cursor to indicate that an action trigger has been received. In some implementations, the system generates a zoomed in view of a portion of a graphical user interface at a location of the cursor when an action trigger is received.

After the system applies the action associated with the received action trigger, the process 300 returns. In some implementations, the system continues to generate a cursor on a touchscreen device and continues to provide for an extended touch input after applying an action. For example, the system may enable a user to select and drag an element of a graphical user interface via a cursor and an extended touch input. In some implementations, the system causes a touchscreen device to stop drawing a cursor after an action associated with an action trigger has been performed at a location of a cursor.

### CONCLUSION

The disclosed system and method enable touch input by a user at a location that is extended in distance from the touch input on a touchscreen device. The disclosed system and method apply a touch input received at a first location on a touchscreen device to a location of a cursor displayed by the touchscreen device extended from the touch input. The disclosed system enables a user to more easily provide touch input on a touchscreen device. The disclosed system helps a user to more easily provide touch input at all locations of a touchscreen device while holding the device with one hand. The disclosed system reduces the likelihood that a user will accidently drop a touchscreen device while trying to provide touch input while holding the device with one hand.

Those skilled in the art will appreciate that the actual implementation of a data storage area may take a variety of forms, and the phrases “data storage” and “data storage area” are used herein in the generic sense to refer to any area that allows data to be stored in a structured and accessible fashion using such applications or constructs as databases, tables, linked lists, arrays, and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/We claim:

1. A non-transitory computer-readable storage medium containing instructions for performing a method of receiving a touch input at a location on a touchscreen device that is extended from the touch input, the method comprising:
receiving a request to provide for an extended touch input;
displaying a cursor, via a touchscreen device, on a graphical user interface displayed by the touchscreen device;
detecting, via the touchscreen device, a touch input;
detecting, via the touchscreen device, a movement of the detected touch input;
calculating a new location for the cursor on the graphical user interface displayed by the touchscreen device,
wherein the new location for the cursor on the graphical user interface is calculated based at least in part on the detected movement of the detected touch input;
displaying the cursor, via the touchscreen device, at the new location for the cursor on the graphical user interface;
detecting, via the touchscreen device, a touch gesture;
identifying an action associated with the detected touch gesture; and
applying the action associated with the detected touch gesture at the new location for the cursor on the graphical user interface,
wherein the new location for the cursor on the graphical user interface is different from a location of the detected touch gesture on the graphical user interface.

2. The non-transitory computer-readable storage medium of claim 1, wherein calculating a new location for the cursor on the graphical user interface displayed by the touchscreen device includes:
calculating a cursor offset based at least in part on applying a movement weight to the detected movement of the detected touch; and
determining the new location for the cursor on the graphical user interface based at least in part on an initial location on the graphical user interface and the calculated cursor offset.

3. The non-transitory computer-readable storage medium of claim 1, wherein:
displaying a cursor, via a touchscreen device, on a graphical user interface includes displaying the cursor at an initial location; and
calculating a new location for the cursor on the graphical user interface displayed by the touchscreen device includes:
calculating a cursor offset based at least in part on the detected movement of the detected touch, and
adding the cursor offset to the initial location of the cursor.

4. The non-transitory computer-readable storage medium of claim 1, wherein:
displaying a cursor, via a touchscreen device, on a graphical user interface includes displaying the cursor at an initial location; and
calculating a new location for the cursor on the graphical user interface displayed by the touchscreen device includes:
calculating a cursor offset based at least in part on the detected movement of the detected touch multiplied by a movement weight, and
adding the cursor offset to the initial location of the cursor.

5. The non-transitory computer-readable storage medium of claim 1, wherein:
detecting, via the touchscreen device, a touch gesture includes detecting a release of the touch gesture from the touchscreen device;
identifying the action associated with the detected touch gesture includes identifying a pointer down event; and
applying the action associated with the detected touch gesture at the new location for the cursor includes applying a pointer down event at the new location for the cursor.

6. The non-transitory computer-readable storage medium of claim 1, wherein:
applying the action associated with the detected touch gesture at the new location for the cursor includes changing visual appearance details of the cursor when the action is applied.

7. The non-transitory computer-readable storage medium of claim 1, further comprising displaying an action indicator at a location of the detected touch gesture.

8. The non-transitory computer-readable storage medium of claim 1, wherein receiving a request to provide for an extended touch input includes:
receiving a selection by a user of an icon associated with launching a cursor for extended touch input.

9. The non-transitory computer-readable storage medium of claim 8, further comprising:
determining that the touchscreen device is being held in one of a left hand or a right hand; and
determining a location on a graphical user interface for displaying the icon associated with launching the cursor for extended touch input based at least in part on the determination of one of the left hand or the right hand holding the touchscreen device.

10. A method performed by a touchscreen computing device for receiving a touch input at a location on the touchscreen computing device that is extended from the touch input, the method performed by a processor executing instructions stored in a memory, the method comprising:
receiving a request to provide for an extended touch input;
displaying a cursor, via the touchscreen computing device, on a graphical user interface displayed by the touchscreen device;
detecting, via the touchscreen computing device, a touch input;
detecting, via the touchscreen computing device, a movement of the detected touch input;
calculating a new location for the cursor on the graphical user interface displayed by the touchscreen device,
wherein the new location for the cursor on the graphical user interface is calculated based at least in part on the detected movement of the detected touch input;
displaying the cursor, via the touchscreen computing device, at the new location for the cursor on the graphical user interface;
detecting, via the touchscreen computing device, a touch gesture;
identifying an action associated with the detected touch gesture; and
applying the action associated with the detected touch gesture at the new location for the cursor on the graphical user interface,
wherein the new location for the cursor on the graphical user interface is different from a location of the detected touch gesture on the graphical user interface.

11. The method of claim 10, wherein calculating a new location for the cursor on the graphical user interface displayed by the touchscreen computing device includes:
calculating a cursor offset based at least in part on applying a movement weight to the detected movement of the detected touch; and
determining the new location for the cursor on the graphical user interface based at least in part on an initial location on the graphical user interface and the calculated cursor offset.

12. The method of claim 10, wherein:
displaying a cursor, via the touchscreen computing device, on a graphical user interface includes displaying the cursor at an initial location; and
calculating a new location for the cursor on the graphical user interface displayed by the touchscreen computing device includes:
calculating a cursor offset based at least in part on the detected movement of the detected touch, and
adding the cursor offset to the initial location of the cursor.

13. The method of claim 10, wherein:
displaying a cursor, via the touchscreen computing device, on a graphical user interface includes displaying the cursor at an initial location; and
calculating a new location for the cursor on the graphical user interface displayed by the touchscreen computing device includes:
calculating a cursor offset based at least in part on the detected movement of the detected touch multiplied by a movement weight, and
adding the cursor offset to the initial location of the cursor.

14. The method of claim 10, wherein:
detecting, via the touchscreen computing device, a touch gesture includes detecting a release of the touch gesture from the touchscreen device;
identifying the action associated with the detected touch gesture includes identifying a pointer down event; and
applying the action associated with the detected touch gesture at the new location for the cursor includes applying a pointer down event at the new location for the cursor.

15. The method of claim 10, wherein:
applying the action associated with the detected touch gesture at the new location for the cursor includes changing visual appearance details of the cursor when the action is applied.

16. The method of claim 10, wherein receiving a request to provide for an extended touch input includes:
receiving a selection by a user of an icon associated with launching a cursor for extended touch input.

17. The method of claim 16, further comprising:
determining that the touchscreen computing device is being held in one of a left hand or a right hand; and
determining a location on a graphical user interface for displaying the icon associated with launching the cursor for extended touch input based at least in part on the one of the left hand or the right hand holding the touchscreen device.

18. A system for receiving a touch input at a location on a touchscreen computing device that is extended from the touch input, the system comprising:
means for receiving a request to provide for an extended touch input;
means for displaying a cursor, via a touchscreen device, on a graphical user interface displayed by the touchscreen device;
means for detecting, via the touchscreen device, a touch input;
means for detecting, via the touchscreen device, a movement of the detected touch input;
means for calculating a new location for the cursor on the graphical user interface displayed by the touchscreen device,
wherein the new location for the cursor on the graphical user interface is calculated based at least in part on the detected movement of the detected touch input;
means for displaying the cursor, via the touchscreen device, at the new location for the cursor on the graphical user interface;
means for detecting, via the touchscreen device, a touch gesture;
means for identifying an action associated with the detected touch gesture; and
means for applying the action associated with the detected touch gesture at the new location for the cursor on the graphical user interface,
wherein the new location for the cursor on the graphical user interface is different from a location of the detected touch gesture on the graphical user interface.

19. The system of claim 18, wherein the means for calculating a new location for the cursor on the graphical user interface displayed by the touchscreen device includes:
means for calculating a cursor offset based at least in part on applying a movement weight to the detected movement of the detected touch; and
means for determining the new location for the cursor on the graphical user interface based at least in part on an initial location on the graphical user interface and the calculated cursor offset.

20. The system of claim 18, wherein means for receiving a request to provide for an extended touch input includes means for receiving a selection by a user of an icon associated with launching a cursor for extended touch input, and wherein the system further comprises:
means for determining that the touchscreen computing device is being held in one of a left hand or a right hand; and
means for determining a location on a graphical user interface for displaying the icon associated with launching the cursor for extended touch input based at least in part on the one of the left hand or the right hand holding the touchscreen device.
